(19) United States
(12) Patent Application Publication
(10) Pub. No.: US 2026/0166353 A1
(43) Pub. Date: Jun. 18, 2026

(54) FIRE RESPONSE SYSTEM AND METHOD FOR ELECTRIC VEHICLES IN CHASSIS DYNAMOMETER TEST ENVIRONMENT

(71) Applicants: HYUNDAI MOTOR COMPANY, Seoul (KR); Kia Corporation, Seoul (KR); INOZEST Co.,LTD., Anyang-si (KR)

(72) Inventors: KIHYUN LEE, Hwaseong-si (KR); YOUNG KEE PARK, Hwaseong-si (KR); HYOUNGBIN LIM, Hwaseong-si (KR); Seung-hyup SONG, Anyang-si (KR); Chang-jun Lee, Anyang-si (KR); Jung-hun Kim, Siheung-si (KR)

(21) Appl. No.: 19/201,433

(22) Filed: May 7, 2025

(30) Foreign Application Priority Data
Dec. 18, 2024 (KR) 10-2024-0190556

(51) Int. Cl. A62C 3/07; A62C 3/06; A62C 37/40; A62C 99/00

(52) U.S. Cl. CPC A62C 3/07; A62C 3/06; A62C 37/40; A62C 99/0009

(57) ABSTRACT

A fire response system for electric vehicles includes a chassis dynamometer, a main roller, a deployable fire extinguisher tub, an electric winch, a sensor, and a controller. The chassis dynamometer provides a space for a predetermined test on a test vehicle located in a test zone. The main roller is provided on one side of the test zone, and the deployable fire extinguisher tub is connected to the main roller through unwinding wires to be wound around the main roller or unwound from the main roller. The electric winch is disposed on an opposite side of the test zone and connected to the deployable fire extinguisher tub by winding wires. The sensor collects predetermined information from the test vehicle. The controller deploys the deployable fire extinguisher tub below the test vehicle under a predetermined condition and supplies fire extinguishing water to submerge the test vehicle therein.

### CROSS-REFERENCE TO RELATED APPLICATION

This application is based on and claims the benefit of 35 U.S.C. 119 to Korean Patent Application No. 10-2024-0190556, filed on Dec. 18, 2024, in the Korean Intellectual Property Office, the disclosure of which is herein incorporated by reference in its entirety.

### TECHNICAL FIELD

The present disclosure relates to a fire response system and apparatus for electric vehicles in a chassis dynamometer test environment, and more particularly, to a system and method that prevent a risk occurring in a chassis dynamometer test environment by submerging a test vehicle in water up to the height of batteries when a predetermined condition is detected.

### BACKGROUND

Electric vehicles may include batteries. Battery-related technology is important for electric vehicles. For example, batteries are closely related to range, charging time, lifespan, cost, etc., and particularly, many experiments and studies are being conducted to raise safety.

Lithium-ion batteries, which are widely used in electric vehicles, are efficient because they have high energy density. However, lithium-ion batteries have a disadvantage in that they are vulnerable to high temperatures and impacts. In some cases, battery overheating may cause thermal runaway, thereby being capable of leading to serious safety incidents.

A charging infrastructure may rapidly charge batteries. In some cases, a battery temperature rise during the charging process may still be a problem, and if there is no separate control technology to control battery temperature.

In some cases, more stringent safety management may be implemented in a test environment in which the performance of electric vehicles is developed and verified. In a chassis dynamometer test to evaluate the performance and durability of vehicles, extreme conditions may be set to test the drivetrains and batteries of the vehicles. During this process, abnormal situations, such as battery overheating, may occur due to an excessive load.

Various risk factors may be detected in a high-temperature and high-load chassis dynamometer test environment for vehicle tests.

### SUMMARY

The present disclosure can help protect test equipment and a test vehicle, which may be damaged due to various abnormal situations that can occur during a chassis dynamometer test.

The present disclosure can help contain thermal runaway that may occur momentarily due to unexpected battery overheating when conducting a chassis dynamometer test on an electric vehicle or a hybrid electric vehicle.

The present disclosure may help protect human life and property when an abnormal situation occurs during a chassis dynamometer test.

According to one aspect of the subject matter described in this application, a fire response system for an electric vehicle in a test zone includes a main roller disposed at a first side of the test zone, a deployable fire extinguisher tub connected to the main roller through a plurality of unwinding wires and configured to be wound around and unwound from the main roller, where an area of the deployable fire extinguisher tub is greater than an area of the test zone, an electric winch disposed at a second side of the test zone and connected to the deployable fire extinguisher tub by a plurality of winding wires, a status measurer configured to collect information from the electric vehicle, and a controller configured to (i) deploy the deployable fire extinguisher tub to thereby define a water storage space below the electric vehicle based on the information satisfying a preset condition and (ii) supply fire extinguishing water to the water storage space to thereby submerge at least a portion of the electric vehicle in the fire extinguishing water.

Implementations according to this aspect can include one or more of the following features. For example, the deployable fire extinguisher tub can have (i) a first side connected to the main roller through the plurality of unwinding wires and (ii) a second side connected to the electric winch through the plurality of winding wires, where the deployable fire extinguisher tub is configured to be unwound from the main roller and cover the test zone based on rotation of the electric winch. In some examples, the fire response system can include a guide roller disposed between the main roller and the test zone and configured to press downward at least one of (i) the plurality of winding wires, (ii) the deployable fire extinguisher tub, or (iii) the plurality of unwinding wires that are unwound from the main roller.

In some implementations, the fire response system can include an elevating roller configured to raise and lower the plurality of winding wires connected to the electric winch while supporting the plurality of winding wires, where the elevating roller is configured to adjust a height of the plurality of winding wires in at least a portion between the electric winch and the test zone. In some examples, the deployable fire extinguisher tub can include a waterproof cloth having an area larger than the test zone, and an air wall disposed along an outer circumference of the waterproof cloth, where the air wall is configured (i) to be in a flat undeployed state with a preset length and (ii) to inflate based on air being injected through an injection hole to thereby form an air pocket along the outer circumference of the waterproof cloth.

In some implementations, the fire response system can include a guide plate connected to the second side of the waterproof cloth facing the electric winch, a bending surface from which the guide plate is folded relative to the waterproof cloth, and a pair of water barriers configured to connect the air wall to a pair of sides of the guide plate, respectively. In some examples, the guide plate can include a deployment end that defines a front end of the guide plate, wherein a width of the deployment end is less than an overall width of the electric vehicle and greater than a track width of the electric vehicle, and a plurality of winch connection holes that are defined at edges of the deployment end and spaced apart from one another by a spacing corresponding to the track width of the electric vehicle, where the plurality of winding wires are connected to the plurality of winch connection holes, respectively.

In some implementations, the waterproof cloth can include a rigidity reinforcement member disposed in at least an area of the waterproof cloth and configured to enhance rigidity of the waterproof cloth. For instance, the rigidity reinforcement member comprises a fabric attached to the waterproof cloth.

In some examples, the fire response system can include a chassis dynamometer that defines the test zone and is configured to perform a preset test on the test vehicle located in the test zone, where the one or more sensors are disposed at the chassis dynamometer.

According to another aspect, a fire response method for an electric vehicle in a test zone includes collecting information about the test zone and the electric vehicle, receiving, by a controller, the collected information, determining, by the controller in real time, whether the collected information satisfies a preset condition, based on the preset condition being satisfied, deploying a deployable fire extinguisher tub to thereby define a water storage space below the electric vehicle, supplying fire extinguishing water to the water storage space to thereby submerge the electric vehicle in the fire extinguishing water, and draining the fire extinguishing water from the water storage space defined by the deployable fire extinguisher tub.

Implementations according to this aspect can include one or more of the following features. For example, deploying the deployable fire extinguisher tub can include unwinding the deployable fire extinguisher tub from a main roller disposed at a first side of the test zone by rotating an electric winch disposed at a second side of the test zone to thereby horizontally deploy the deployable fire extinguisher tub to a position between the electric vehicle and driving rollers such that the deployable fire extinguisher tub covers the test zone, inflating an air wall of the deployable fire extinguisher tub to a preset height by injecting air into the air wall, the air wall surrounding at least a portion of an outer circumference of the electric vehicle, and erecting a guide plate disposed at an end of the deployable fire extinguisher tub, where the water storage space is defined by (i) the guide plate, (ii) the air wall of the deployable fire extinguisher tub, and (iii) a bottom portion of the deployable fire extinguisher tub between the electric vehicle and the driving rollers define the water storage space, and supplying the fire extinguishing water to the water storage space comprises opening a fire extinguishing water valve.

### BRIEF DESCRIPTION OF THE DRAWINGS

The above and other objects, features and other advantages of the present disclosure will be more clearly understood from the following detailed description taken in conjunction with the accompanying drawings.

FIG. 1 is a conceptual diagram illustrating an example of a chassis dynamometer laboratory space for a fire response system for electric vehicles.

FIG. 2 is a front view schematically showing an example of the fire response system for electric vehicles.

FIG. 3 is a side view schematically showing the fire response system for electric vehicles.

FIG. 4 is a perspective view showing an example of a deployable fire extinguisher tub in the fire response system for electric vehicles.

FIGS. 5 and 6 are views illustrating an example of a process of deploying the deployable fire extinguisher tub between a test vehicle and driving rollers in the fire response system for electric vehicles.

FIG. 7 is a plan view illustrating an example structure of the deployable fire extinguisher tub in the fire response system for electric vehicles.

FIG. 8 is a plan view illustrating an example structure of a waterproof cloth in the fire response system for electric vehicles.

FIG. 9 is a block diagram briefly illustrating example components of the fire response system for electric vehicles.

### DETAILED DESCRIPTION

Hereinafter, reference will be made in detail to one or more implementations of the present disclosure, examples of which are illustrated in the accompanying drawings. Wherever possible, the same reference numbers will be used throughout the drawings to refer to the same or similar components, and a redundant description thereof will be omitted.

In the present disclosure, a first direction (X-axis direction), a second direction (Y-axis direction), and a third direction (Z-axis direction) stated in the following description are used to describe a three-dimensional shape in a three-dimensional space, and indicate directions that are orthogonal to each other.

The present disclosure relates to a fire response system for electric vehicles and a fire response method for electric vehicles using the same.

Particularly, the present disclosure can be applied to a specific test environment or facility, such as a test environment using a chassis dynamometer 100.

In the chassis dynamometer test environment, various unexpected situations can occur. In some cases, these situations can cause loss of human life or damage to equipment.

Accordingly, the fire response system and method according to the present disclosure prevent dangerous situations and accidents in advance by quickly detecting and quickly responding to predetermined situations in such an environment.

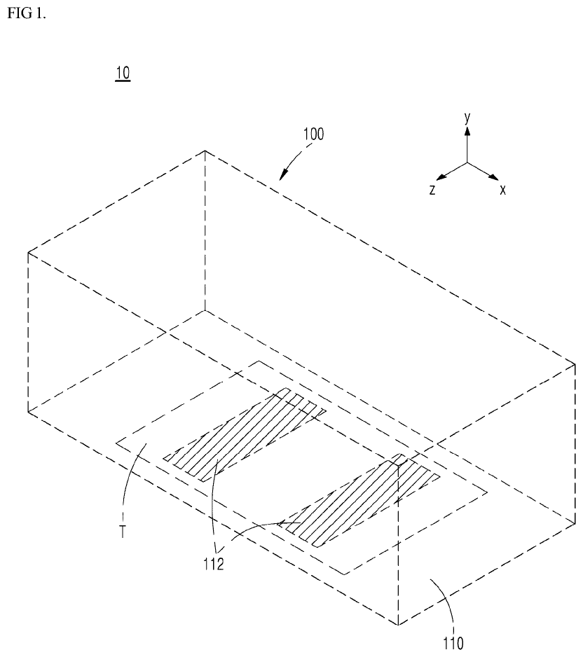

FIG. 1 is a conceptual diagram illustrating a chassis dynamometer laboratory space to which the fire response system for electric vehicles is applicable.

A test booth 10 can be designed to have an open or closed structure suitable for a predetermined space. A test zone T in which an electric vehicle 1 is disposed is formed in the test booth 10.

The test zone T is formed with a larger area than the electric vehicle 1 so that the electric vehicle 1 does not leave the test zone T.

The fire response system according to the present disclosure can also be applied to a test environment or a test space, as shown in FIG. 1.

The chassis dynamometer 100 is a device that simulates the driving status of a vehicle to mainly evaluate engine performance, drivetrain operation, battery efficiency, etc. The electric vehicle 1 is mostly operated under unusually harsh conditions.

Referring to FIG. 1, the chassis dynamometer 100 has a flat base plate 110 as the bottom surface thereof. In addition, the test booth 10 can be implemented as a sealed test booth 10 separated from the outside, or can be implemented as a test booth 10 having at least a part opened with respect the base plate 110.

The test zone T is formed in a partial area of the upper surface of the base plate 110. The test zone T has a predetermined area, and is formed to clearly distinguish an area where the electric vehicle 1 is to be disposed.

The electric vehicle 1 is disposed on the test zone T. The front and rear wheels of the electric vehicle 1 are placed on driving rollers 112 at corresponding positions, respectively. In some implementations, the electric vehicle 1 can be disposed on the test zone T so that the normal driving direction thereof is the X-axis direction.

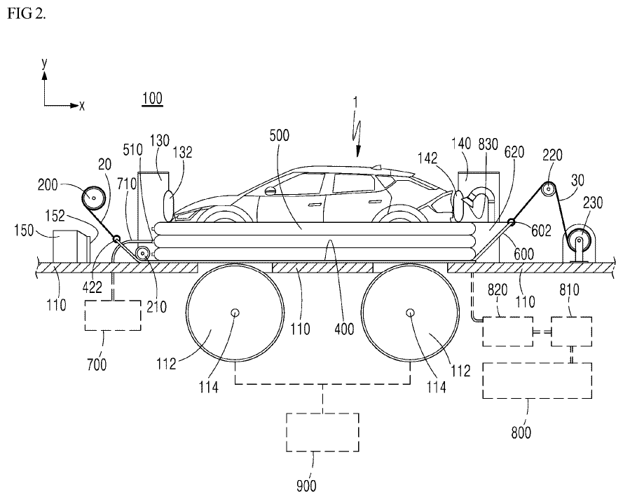

FIG. 2 is a front view schematically showing the fire response system for electric vehicles.

As shown in FIG. 2, the electric vehicle 1 can be disposed and fixed inside the test zone T. The electric vehicle 1 is set so as not to deviate from a predetermined area inside the test zone T. The chassis dynamometer 100 can further include a fixing module 120 that fixes the electric vehicle 1 within the allowed area inside the test zone T.

The fixing module 120 can include a plurality of fixing arms, such as a first fixing arm 130 and a second fixing arm 140. The first fixing arm 130 can include a first pressing member 132 that comes into contact with the body of the electric vehicle 1, and the second fixing arm 140 can include a second pressing member 142 that presses and fixes the electric vehicle 1 together with the first pressing member 132.

The chassis dynamometer 100 can include a blower module 150 that forms an air flow around the electric vehicle 1 depending on a test situation. The blower module 150 is provided with a blower hole 152 that induces the air flow in a predetermined direction.

The electric vehicle 1 is placed on the driving rollers 112 so that a pair of front wheels and a pair of rear wheels come into contact with the driving rollers 112 at corresponding positions, respectively. The respective driving rollers 112 rotate around corresponding drive shafts 114 arranged parallel to each other, driving conditions predetermined in the electric vehicle 1 can be simulated through the rotational motion of the driving rollers 112.

The fire response system includes the chassis dynamometer 100, a main roller 200, a deployable fire extinguisher tub 300, an electric winch 230, a status measurer 920, and a controller 900.

The main roller 200 winds the deployable fire extinguisher tub 300 along the outer circumference thereof to store the deployable fire extinguisher tub 300. The main roller 200 is connected to the deployable fire extinguisher tub 300 through at least two unwinding wires 20.

The main roller 200 is spaced apart from one side of the test zone T by a predetermined distance. The main roller 200 can be installed in front of the electric vehicle 1 based on the electric vehicle 1 disposed in the test zone T.

The main roller 200 can include a cylindrical core member formed such that at least a portion thereof is longer than the width of the test zone T. When the main roller 200 rotates around the longitudinal direction (Z-axis direction), the unwinding wires 20 connected to the main roller 200 are wound around the outer circumference of the main roller 200.

In addition, the plurality of unwinding wires 20 pulls the positions thereof connected to the deployable fire extinguisher tub 300 respectively so that the deployable fire extinguisher tub 300 is wound around the outer circumference of the main roller 200 without any wrinkles.

As such, the deployable fire extinguisher tub 300 can be stored while being wound around the outer circumference of the main roller 200.

The electric winch 230 is installed at a position spaced apart rearward from the test zone T by a predetermined distance opposite the main roller 200.

For example, the test zone T is located between the main roller 200 and the electric winch 230.

The main roller 200 and the electric winch 230 can be arranged on the same plane, and the rotation axes thereof can be set parallel to each other.

In some examples, the deployable fire extinguisher tub 300 can be connected to the unwinding wires 20 and winding wires 30 at several positions along the outer circumference of the deployable fire extinguisher tub 300.

A pair of unwinding wires 20 connects the deployable fire extinguisher tub 300 to the main roller 200, and pulls the deployable fire extinguisher tub 300 to be wound around the main roller 200 or allows the deployable fire extinguisher tub 300 to be unwound from the main roller 200 in the longitudinal direction of each unwinding wire 20 so as to be deployed, depending on the rotation of the main roller 200.

A pair of winding wires 30 connects the deployable fire extinguisher tub 300 to the electric winch 230, and pulls the deployable fire extinguisher tub 300 toward the electric winch 230 so that the deployable fire extinguisher tub 300 is unwound from the main roller 200, when the electric winch 230 rotates in a predetermined direction.

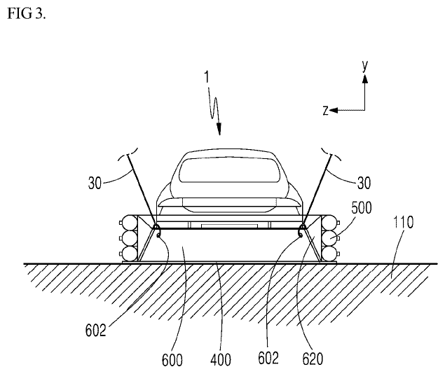

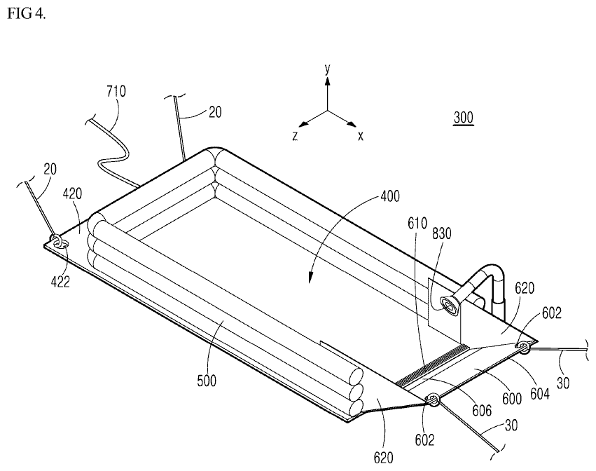

FIG. 3 is a side view schematically showing the fire response system for electric vehicles, and FIG. 4 is a perspective view showing the deployable fire extinguisher tub 300 in the fire response system for electric vehicles.

As shown in FIGS. 3 and 4, the deployable fire extinguisher tub 300 includes a waterproof cloth 400, an air wall 500, and a guide plate 600.

The deployable fire extinguisher tub 300 is formed to be sufficiently wide to cover the entire upper surface of the test zone T, and has an overall thin thickness.

The waterproof cloth 400, which is a water-repellent cloth, can be implemented in various shapes, such as a rectangle, a circle, and a hexagon, and the waterproof cloth 400 is formed to have an area that can cover the entire upper surface of the test zone T.

The waterproof cloth 400 can have a connection end 420 having coupling holes 422 to which the unwinding wires 20 are connected, and an entry end 430 formed in a direction opposite the connection end 420 so that the guide plate 600 is coupled to the entry end 430.

The air wall 500 can be formed long along the outer edge of the upper surface of the waterproof cloth 400.

The air wall 500 is formed continuously with a predetermined width along the outer perimeter of the waterproof cloth 400. Both ends of the air wall 500 can be connected to both sides of the entry end 430 to which the guide plate 600 is coupled.

The sizes of the air wall 500 and the guide plate 600 can be determined in consideration of the overall width and overall length of the electric vehicle 1.

Therefore, when the deployable fire extinguisher tub 300 forms a water storage space, the outer circumference of the electric vehicle 1 can be surrounded by the air wall 500 and the guide plate 600.

The air wall 500 can be implemented as a tube in which air can be stored. When air is injected, the air wall 500 is inflated and forms a wall along a predetermined path. The air wall 500 can include at least one injection hole 510. The injection hole 510 is an air inlet into which air can be injected through a compressor 700 and an air hose 710.

The air wall 500 is folded flat and maintained in a state of being closely adhered to the surface of the waterproof cloth 400 before air is injected through the injection hole 510.

The entry end 430 can be formed in a partial section of the outer circumference of the waterproof cloth 400.

In some examples, the waterproof cloth 400 can be formed in a rectangular shape.

The waterproof cloth 400 can be formed in a rectangular shape in which two short sides and two long sides are formed parallel to each other, and among the two short sides, one short side adjacent to the main roller 200 can be formed as the connection end 420.

In addition, the other short side close to the electric winch 230 opposite the connection end 420 is formed as the entry end 430.

The air wall 500 can be formed long with a predetermined width along the connection end 420 of the waterproof cloth 400 and the two long sides connected to both sides of the connection end 420.

The air wall 500 is formed to surround a certain section of the outer circumference of the waterproof cloth 400, and both ends of the air wall 500 are connected to both sides of the entry end 430 formed on the waterproof cloth 400.

The guide plate 600 is connected to the entry end 430. The guide plate 600 is formed as a plate-shaped member formed of a material having relatively high durability and rigidity, such as metal or plastic, to have a relatively thin thickness.

The guide plate 600 includes a traction end 606 located adjacent to the entry end 430, and a deployment end 604 formed in a straight line that extends in the opposite direction to the traction end 606 and faces the electric winch 230 with respect to the waterproof cloth 400.

The traction end 606 is connected to the entry end 430 of the waterproof cloth 400 through a bending surface 610. The bending surface 610 is formed so that the guide plate 600 can be naturally inclined at a predetermined angle with respect to the waterproof cloth 400.

That is, a plurality of winch connection holes 602 is formed at positions of the guide plate 600 adjacent to the deployment end 604, and each winch connection hole 602 is connected to a corresponding one of the winding wires 30.

The plurality of winding wires 30 can exert tensile forces of different magnitudes and direction on the deployment end 604 of the guide plate 600. When external force is applied to the guide plate 600 through the plurality of winding wires 30, the guide plate 600 is flexibly bent from the waterproof cloth 400 around the bending surface 610 to be erected.

As shown in FIGS. 3 and 4, when the deployable fire extinguisher tub 300 is unwound from the main roller 200 and deployed over the test zone T, the electric vehicle 1 is placed on the deployable fire extinguisher tub 300.

In some examples, the deployable fire extinguisher tub 300 passes through an area where the tires of the electric vehicle 1 and the surfaces of the respective driving rollers 12 are in contact with each other, and covers the upper surface of the test zone T. Because the positions of the test zone T and the electric vehicle 1 are limited, the deployable fire extinguisher tub 300 forms a layer (floor surface) that vertically divides the electric vehicle 1 and the test zone T.

In some examples, the waterproof cloth 400 covers the test zone T formed on the base plate 110, and the electric vehicle 1 is located thereon. When the deployable fire extinguisher tub 300 is deployed toward the electric winch 230 and widely spreads below the electric vehicle 1 between the main roller 200 and the electric winch 230, the controller 900 operates the compressor 700, and the air hose 710 connected to the compressor 700 injects air through the injection hole 510 to inflate the air wall 500. For example, the controller 900 can include an electric circuit, a processor, a microprocessor, a computer, etc.

The waterproof cloth 400 forms the bottom surface of the water storage space, and the air wall 500 and the guide plate 600 are connected to the waterproof cloth 400 to form a water storage wall so that water can be stored.

As illustrated, the air wall 500 forms a long and continuous wall around three sides of the rectangular waterproof cloth 400, and in a section corresponding to the entry end 430 to which the air wall 500 is not connected, the guide plate 600 is erected at a predetermined angle to form a wall.

A water barrier 620 is provided on each of both sides of the guide plate 600. Each water barrier 620 blocks a space between the side end of the air wall 500 and the guide plate 600 to prevent water leakage even if the inclination of the guide plate 600 changes.

When the air wall 500 is inflated to form the wall to a predetermined height and the guide plate 600 and the air wall 500 form the water storage space on the waterproof cloth 400, the controller 900 operates a pump 810 connected to a water storage tank 800 and opens a fire extinguishing water valve 820 that was closing a fire extinguishing water nozzle 830.

The controller 900 fills the water storage space created by the waterproof cloth 400, the air wall 500, and the guide plate 600 with fire extinguishing water through the fire extinguishing water nozzle 830 so that the electric vehicle 1 on the deployable fire extinguisher tub 300 can be submerged in the fire extinguishing water to a predetermined height.

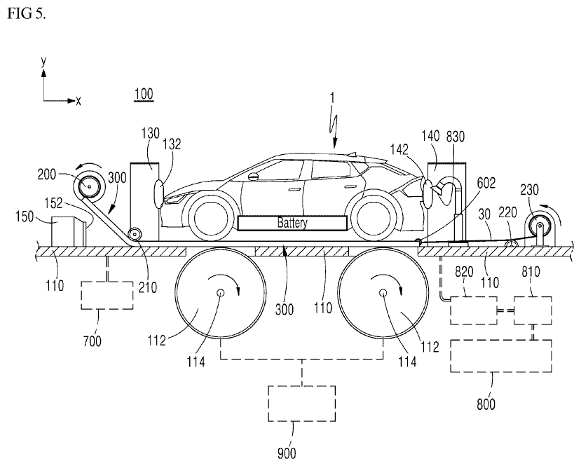

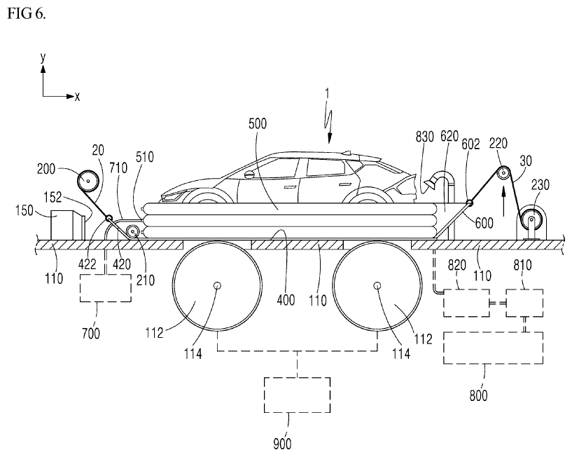

FIGS. 5 and 6 are views illustrating a process of deploying the deployable fire extinguisher tub 300 between the electric vehicle 1 and the driving rollers 112 in the fire response system for electric vehicles.

As shown in FIGS. 5 and 6, the fire response system can be applied to specific test equipment for vehicles.

In the chassis dynamometer 100, the respective driving rollers 112 rotate around the corresponding drive shafts 114 arranged parallel to each other, and all the tires of the electric vehicle 1 are placed on the driving rollers 112. Thereby, the test vehicle q can experience conditions very similar to an actual driving environment even in a state in which the electric vehicle 1 is fixed within the test zone T.

The deployable fire extinguisher tub 300 is installed in front of the test zone T while being wound around the main roller 200.

In the deployable fire extinguisher tub 300 wound around the main roller 200, the entry end 430 and the guide plate 600 are located at the outermost end of the wound deployable fire extinguisher tub 300, and the winding wires 30 are coupled to the plurality of winch connection holes 602 formed in the guide plate 600 so that the guide plate 600 is connected to the electric winch 230.

A performance measurer 910 and the status measurer 920 can be provided on the base plate 110 or in the test booth 10. The performance measurer 910 collects predetermined test information from the electric vehicle 1. For example, the performance measurer 910 and the status measurer 920 can include one or more sensors.

The status measurer 920 monitors the electric vehicle 1 and/or the inside of the test booth 10. The status measurer 920 can monitor predetermined conditions, such as changes in the battery temperature of the electric vehicle 1, indoor air data of the electric vehicle 1, and wear or heat generation of specific tires, in real time.

Information collected through the status measurer 920 is analyzed through the controller 900, and the controller 900 determines in real time whether a predetermined test stop condition is satisfied based on the collected information about the test booth 10, where a test is in progress, the base plate 110, or the electric vehicle 1.

Upon determining that the test stop condition is satisfied by the controller 900, the driving rollers 112 and the drive shafts 114 of the chassis dynamometer 100 can be switched to a neutral state.

Then, the electric winch 230 quickly rotates in a predetermined direction to wind the plurality of winding wires 30, so that the deployable fire extinguisher tub 300 connected to the winding wires 30 is unwound from the main roller 200 and spreads toward the electric winch 230.

In some examples, a guide roller 210 can be provided between the main roller 200 and the test zone T.

The guide roller 210 can be raised or lowered in the vertical direction. When satisfaction of the test stop condition is determined by the controller 900 and the electric winch 230 is operated, the guide roller 210 is lowered vertically downward, and guides the winding wires 30 and the deployable fire extinguisher tub 300 unwound from the main roller 200 to smoothly enter and pass between the driving rollers 112 and the tires of the electric vehicle 1.

Therefore, the guide roller 210 is installed on the winding wires 30, the deployable fire extinguisher tub 300, and the unwinding wires 20, and is lowered depending on a situation to appropriately lower a height at which the winding wires 30, the deployable fire extinguisher tub 300, and the unwinding wires 20 enter below the electric vehicle 1.

An elevating roller 220 is provided between the test zone T and the electric winch 230.

The elevating roller 220 is disposed under the winding wires 30 wound around the electric winch 230 or unwound from the electric winch 230.

The winding wires 30 pass over the elevating roller 220 between the electric winch 230 and the test zone T.

Therefore, as the elevating roller 220 is raised or lowered, the winding wires 30 to be wound around the electric winch 230 can be adjusted to pass a predetermined height between the electric winch 230 and the test zone T.

The elevating roller 220 is lowered to a position close to the surface of the base plate 110 while the electric winch 230 rotates to pull the winding wires 30 and unwind the deployable fire extinguisher tub 300 from the main roller 200. For example, force that pulls the winding wires 30, the deployable fire extinguisher tub 300, and the unwinding wires 20, that are wound toward the electric winch 230, toward the electric winch 230 is applied in a straight direction as much as possible in a section between the test zone T and the electric vehicle 1.

When the deployable fire extinguisher tub 300 is deployed to sufficiently cover the test zone T and the electric vehicle 1 is located in the water storage space formed by the waterproof cloth 400 and the air wall 500, the elevating roller 220 is raised upward and elevates the winding wires 30 to a predetermined height.

Therefore, as shown in FIG. 6, the winding wires 30 connected to the winch connection holes 602 adjacent to the deployment end 604 of the guide plate 600 enable the guide plate 600 to be erected so that the guide plate 600 together with the air wall 500 can form a partial section of the water barrier of the water storage space.

Through this process, when the controller 900 determines that the test stop condition is satisfied, the deployable fire extinguisher tub 300 is unwound to form the water storage space, and the controller 900 opens the fire extinguishing water valve 820 to supply fire extinguishing water so that the electric vehicle 1 can be submerged in the fire extinguishing water to a predetermined height.

The fire extinguishing water supplied to the deployable fire extinguisher tub 300 through the fire extinguishing water nozzle 830 can be quickly drained to a sewage tank through a separately provided drainage hole after serving a predetermined purpose, such as cooling batteries or extinguishing a fire.

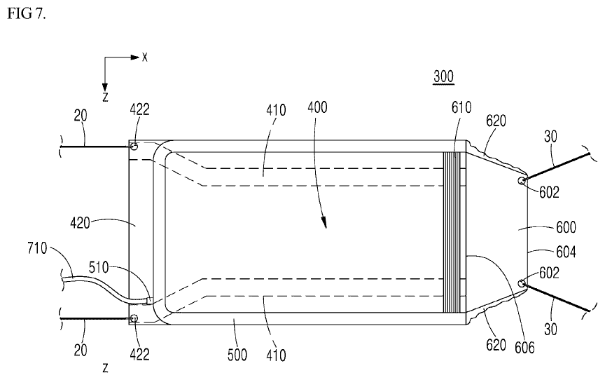

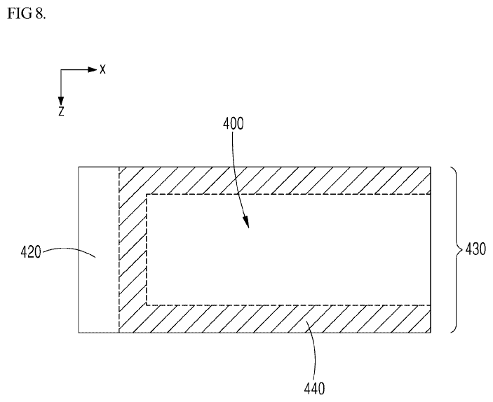

FIG. 7 is a plan view illustrating the structure of the deployable fire extinguisher tub 300 in the fire response system for electric vehicles, and FIG. 8 is a plan view illustrating the structure of the waterproof cloth 400 in the fire response system for electric vehicles.

As shown in FIG. 7, in the fire response system for electric vehicles, the waterproof cloth 400 can include rigidity reinforcement members 410.

The rigidity reinforcement members 410 are provided at positions corresponding to the tires of the electric vehicle 1 when the deployable fire extinguishing tub 300 is deployed below the electric vehicle 1. The rigidity reinforcement members 410 are provided by adding a fabric having high friction resistance and high durability to the surface or the inside of the waterproof cloth 400, and reinforce some sections of the waterproof cloth 400 to have higher rigidity. In addition, the rigidity reinforcement members 410 can be provided to connect the winch connection holes 602 and the coupling holes 422 of the connection end 420 in the X-axis direction.

Thereby, force in a plane direction can be transmitted better between the winch connection holes 602 and the coupling holes 422 where tensile force is concentrated through the unwinding wires 20 and the winding wires 30.

The traction end 606 of the guide plate 600 is connected to the entry end 430 of the waterproof cloth 400. Specifically, the bending surface 610 is interposed between the traction end 606 and the entry end 430.

The bending surface 610 serves to firmly connect the waterproof cloth 400 and the traction end 606 of the guide plate 600, and also serves to facilitate erection of the guide plate 600 at a designated angle with respect to the waterproof cloth 400.

The traction end 606 of the guide plate 600 can have a width greater than the overall width of the electric vehicle 1, and the opposite deployment end 604 can have a length smaller than the overall width of the electric vehicle 1 and greater than the track width of the electric vehicle 1. In addition, if the number of the plurality of winch connection holes 602 formed adjacent to the deployment end 603 is a pair, the winch connection holes 602 are formed around the deployment end 604 of the guide plate 600 to have the same spacing as the track width of the electric vehicle 1.

As shown in FIG. 8, in the fire response system, the waterproof cloth 400 includes the connection end 420 formed relatively close to the main roller 200, and the entry end 430 formed relatively close to the electric winch 230. In addition, the waterproof cloth 400 can have an extended deformation section 440 formed continuously with a predetermined width along the outer edges of the two facing long sides and a position adjacent to the connection end 420. The air wall 500 is installed on the extended deformation section 440.

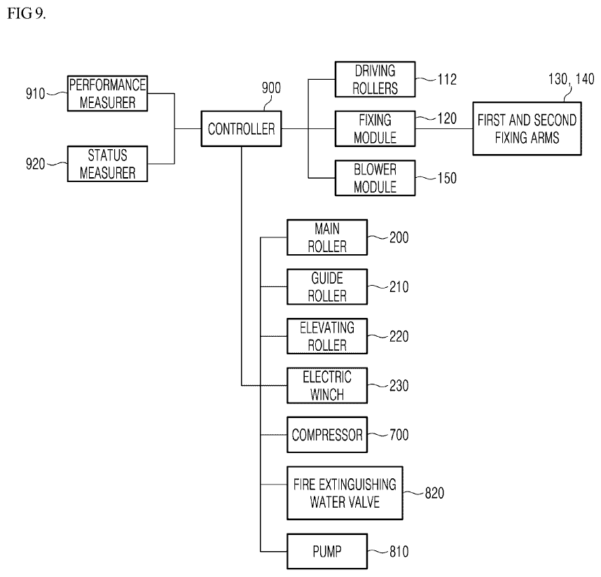

FIG. 9 is a block diagram briefly illustrating main components of the fire response system for electric vehicles.

Referring to the block diagram shown in FIG. 9, the fire response method can be implemented using the above-described fire response system.

The fire response method includes collecting predetermined information about the test booth 10, where a test is in progress, and the electric vehicle 1 and transmitting the information to the controller 900 (S10), determining, by the controller 900, in real time whether a predetermined test stop condition is satisfied based on the collected information (S20), deploying the deployable fire extinguisher tub 300 below the electric vehicle 1 to form a water storage space and submerging the electric vehicle 1 in fire extinguishing water to a predetermined height, upon determining that the test stop condition is satisfied (S30), and quickly draining the fire extinguishing water from the deployable fire extinguisher tub 300 (S40).

In addition, Operation S30 can include horizontally deploying the deployable fire extinguisher tub 300, forming the air wall 500, completing the formation of the water storage space, and supplying the fire extinguishing water.

In horizontally deploying the deployable fire extinguisher tub 300, the electric winch 230 rotates to unwind the deployable fire extinguisher tub 300 from the main roller 200 so that the deployable fire extinguisher tub 300 is deployed between the electric vehicle 1 and the driving rollers 112 to cover the test zone T.

In forming the air wall 500, air is injected into the air wall 500 to inflate the air wall 500 to a predetermined height so as to surround at least a portion of the outer circumference of the electric vehicle 1.

In completing the formation of the water storage space, the guide plate 600 provided at the entry end 430 so that the deployable fire extinguisher tub 300 is unwound from the main roller 200 and deployed between the electric vehicle 1 and the driving rollers 112 is erected to form a water barrier section connected to the air wall 500.

In supplying the fire extinguishing water, the fire extinguishing water valve 820 is opened so that the electric vehicle 1 is submerged in the fire extinguishing water to the predetermined height.

In some examples, abnormal situations that can occur in the chassis dynamometer test environment of an electric vehicle can be detected more quickly through real-time monitoring.

In some implementations, if a sign of battery overheating or thermal runaway is detected during a test, cooling and fire extinguishing functions corresponding thereto can be immediately operated.

In some implementations, damage to a test booth in which the chassis dynamometer test environment is created and a vehicle put into the test due to abnormal situations can be reduced.

A fire response system including a deployable fire extinguisher tub according to the present disclosure can be advantageous in that it is easily applicable to test environments having various shapes and purposes with different structures.

The effects of the present disclosure are not limited to those mentioned above, and other effects not mentioned herein can be clearly understood by those skilled in the art from the above description.

The implementations of the present disclosure have been described above. It will be apparent that the described implementations and drawings are merely illustrative and can be variously modified within the technical scope of the present disclosure.

The described implementations should be considered as a part of the present disclosure, and the scope of the present disclosure is not limited to these implementations.

The scope of the present disclosure should be determined depending on the technical idea described in the claims.

In addition, it is understood that, even if actions or effects according to a specific configuration are not explicitly described in the described implementations, actions or effects capable of being predicted from the corresponding configuration are within the scope of the present disclosure.

What is claimed is:

1. A fire response system for an electric vehicle in a test zone, comprising:
a main roller disposed at a first side of the test zone;
a deployable fire extinguisher tub connected to the main roller through a plurality of unwinding wires and configured to be wound around and unwound from the main roller, wherein an area of the deployable fire extinguisher tub is greater than an area of the test zone;
an electric winch disposed at a second side of the test zone and connected to the deployable fire extinguisher tub by a plurality of winding wires;
one or more sensors configured to collect information from the electric vehicle; and
a controller configured to (i) deploy the deployable fire extinguisher tub to thereby define a water storage space below the electric vehicle based on the information satisfying a preset condition and (ii) supply fire extinguishing water to the water storage space to thereby submerge at least a portion of the electric vehicle in the fire extinguishing water.

2. The fire response system according to claim 1, wherein the deployable fire extinguisher tub has (i) a first side connected to the main roller through the plurality of unwinding wires and (ii) a second side connected to the electric winch through the plurality of winding wires, and
wherein the deployable fire extinguisher tub is configured to be unwound from the main roller and cover the test zone based on rotation of the electric winch.

3. The fire response system according to claim 2, further comprising a guide roller disposed between the main roller and the test zone and configured to press downward at least one of (i) the plurality of winding wires, (ii) the deployable fire extinguisher tub, or (iii) the plurality of unwinding wires that are unwound from the main roller.

4. The fire response system according to claim 2, further comprising an elevating roller configured to raise and lower the plurality of winding wires connected to the electric winch while supporting the plurality of winding wires, the elevating roller being configured to adjust a height of the plurality of winding wires in at least a portion between the electric winch and the test zone.

5. The fire response system according to claim 1, wherein the deployable fire extinguisher tub comprises:
a waterproof cloth having an area larger than the test zone; and
an air wall disposed along an outer circumference of the waterproof cloth, the air wall being configured (i) to be in a flat undeployed state with a preset length and (ii) to inflate based on air being injected through an injection hole to thereby form an air pocket along the outer circumference of the waterproof cloth.

6. The fire response system according to claim 5, further comprising:
a guide plate connected to the second side of the waterproof cloth facing the electric winch;
a bending surface from which the guide plate is folded relative to the waterproof cloth; and
a pair of water barriers configured to connect the air wall to a pair of sides of the guide plate, respectively.

7. The fire response system according to claim 6, wherein the guide plate comprises:
a deployment end that defines a front end of the guide plate, wherein a width of the deployment end is less than an overall width of the electric vehicle and greater than a track width of the electric vehicle; and
a plurality of winch connection holes that are defined at edges of the deployment end and spaced apart from one another by a spacing corresponding to the track width of the electric vehicle, wherein the plurality of winding wires are connected to the plurality of winch connection holes, respectively.

8. The fire response system according to claim 5, wherein the waterproof cloth comprises a rigidity reinforcement member disposed in at least an area of the waterproof cloth and configured to enhance rigidity of the waterproof cloth.

9. The fire response system according to claim 8, wherein the rigidity reinforcement member comprises a fabric attached to the waterproof cloth.

10. The fire response system according to claim 1, further comprising:
a chassis dynamometer that defines the test zone and is configured to perform a preset test on a test vehicle located in the test zone,
wherein the one or more sensors are disposed at the chassis dynamometer.

11. A fire response method for an electric vehicle in a test zone, comprising:
collecting information about the test zone and the electric vehicle;
receiving, by a controller, the collected information;
determining, by the controller in real time, whether the collected information satisfies a preset condition;
based on the preset condition being satisfied, deploying a deployable fire extinguisher tub to thereby define a water storage space below the electric vehicle;
supplying fire extinguishing water to the water storage space to thereby submerge the electric vehicle in the fire extinguishing water; and
draining the fire extinguishing water from the water storage space defined by the deployable fire extinguisher tub.

12. The fire response method according to claim 11, wherein deploying the deployable fire extinguisher tub comprises:
unwinding the deployable fire extinguisher tub from a main roller disposed at a first side of the test zone by rotating an electric winch disposed at a second side of the test zone to thereby horizontally deploy the deployable fire extinguisher tub to a position between the electric vehicle and driving rollers such that the deployable fire extinguisher tub covers the test zone;
inflating an air wall of the deployable fire extinguisher tub to a preset height by injecting air into the air wall, the air wall surrounding at least a portion of an outer circumference of the electric vehicle; and
erecting a guide plate disposed at an end of the deployable fire extinguisher tub, wherein the water storage space is defined by (i) the guide plate, (ii) the air wall of the deployable fire extinguisher tub, and (iii) a bottom portion of the deployable fire extinguisher tub between the electric vehicle and the driving rollers define the water storage space, and
wherein supplying the fire extinguishing water to the water storage space comprises opening a fire extinguishing water valve.
